(19) United States
(12) Patent Application Publication
(10) Pub. No.: US 2010/0153202 A1
(43) Pub. Date: Jun. 17, 2010

(54) DEVICES, SYSTEMS, AND METHODS FOR PROVIDING AN INCENTIVE TO SELECT A DEPOSIT PRODUCT OFFERED BY A FINANCIAL INSTITUTION

(76) Inventors: N. Carmichael Bender, II, Wilmington, NC (US); Robert C. Giltner, Simpsonville, KY (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/335,886

(22) Filed: Dec. 16, 2008

(51) Int. Cl. G06Q 30/00; G06Q 40/00

(52) U.S. Cl. 705/14.21; 705/30; 705/39; 705/35

(57) ABSTRACT

A computer device is provided for implementing a system configured to encourage a customer to deposit monetary funds in a deposit product serviced by a financial institution, and encourage transactions between a customer and a business entity. The computer device detects a plurality of qualified transactions between the customer and at least one business entity associated with the financial institution. The computer device further notifies the financial institution of the detected transactions upon expiration of the transaction period, such that an increased interest rate can be applied to the deposit product during a reward period. In some instances, the computer device issues a reward credit to the customer in response to the detected at least one qualified transaction. The reward credit is redeemable in exchange for a reward corresponding to a redemption value of the reward credit. Associated systems and methods are also provided.

### BACKGROUND

1. Field of the Invention

The present invention relates to the field of incentive systems for providing incentives to customers to reward and encourage selection of a deposit product offered by a financial institution such as a bank, and also to reward and encourage customer transactions with a business entity such as a restaurant, retail store, or other business.

2. Description of Related Art

The ability of a financial institution, such as a bank, to function depends directly upon the amount of monetary funds deposited therewith by customers. To that end, the financial institution may offer and service deposit products, such as checking and savings accounts, having deposit interest rates associated therewith, to encourage potential customers to select the financial institution as their banking entity. In this regard, the monetary funds of the deposit product may be, for example, loaned to other customers of the financial institution (or loaned to other financial institutions) at a loan interest rate calculated to provide a profit for the financial institution. Further, the financial institution may receive income from fees applied to the deposit product, such as, for example, non-sufficient funds fees and interchange fees associated with a customer transaction device (i.e., a debit card) linked to the deposit product.

Potential customers often compare the offered interest rates associated with deposit products provided by various financial institutions in choosing a financial institution with which to deposit monetary funds. In this regard, financial institutions often aggressively compete with one another to offer potential customers premium interest rates (a fixed interest rate) in order to procure the customer's financial business. As such, it is often desirable to offer incentives to encourage and reward a customer for selecting a particular financial institution. Alternatively to providing premium interest rates, previous rewards systems employed by financial institutions have included providing instantaneous gifts and/or rewards directly in return for transactions (such as opening a checking account, for example), wherein these instantaneous rewards may not be enticing to all potential customers, as only one or a limited variety of gifts may be practically offered by the financial institution. That is, there is an “instant gratification” aspect of an instantaneous “gift-based” incentive system, wherein a selected “free gift” is offered to the potential customer in return for engaging in a business transaction.

In other industries, companies may provide incentives to customers in return for their business. Commonly used incentive programs may include: frequent flier miles; “points” that may be earned in return for money spent by a consumer at a particular retailer and/or service provider; and “cash back” programs wherein businesses provide cash incentives to customers that may be proportional to purchase value. In addition, some business entities, such as restaurants, automobile dealerships, and others, may provide rewards and/or gifts to encourage customers to visit a business location and/or engage in a business transaction with the business entity. In many cases, however, such rewards and/or gifts are pre-selected by the marketing personnel of the business entity for a one-time and/or limited-time promotion, such that if potential customers are not enticed by the reward that is offered, they are often not encouraged to visit and/or engage in a transaction.

Furthermore, while some conventional incentive systems for encouraging transactions between customers and business entities may provide a potential and/or current customer with incentives such as redeemable “points,” “miles,” and/or “cash back” that may be incrementally earned, such incentives often do not provide the customer with the instant ability to redeem the incentive for a selected reward. Other conventional incentive methods may provide unique and/or instantly redeemable incentives (e.g., vouchers) to customers in return for a transaction, such that the customer may be encouraged to engage in the transaction with the business entity, as described in U.S. Patent Publication No. 2007/0078710 to Bender. However, such conventional incentive systems lack the ability to blend the flexibility of a “points-based” incentive system (that may allow a potential customer to select a reward and/or gift that is most likely to encourage a transaction between the customer and the business entity) with an incentive system associated with a financial institution, wherein the financial institution and the business entity are associated in a manner that encourages a customer to transact with both the financial institution and the business entity.

Furthermore, certain “gift-based” conventional incentive systems are often purchased directly by a business entity such that the purchased “gifts” must be stored and distributed to potential customers directly by the business entity. This limitation of conventional incentive systems often limits the capability of the business entity to offer an array of potential gifts and/or rewards from which a potential customer might choose in return for engaging in a selected transaction. Furthermore, conventional incentive systems also must be administered directly by the business entity. For example, a business entity, when offering promotional rewards and/or incentives, may be charged not only with storing the rewards and/or gifts, but also shipping, distributing, and providing customer service with respect to the rewards. Thus, the use of conventional incentive programs may be labor-intensive and require special training and/or additional employee support.

The limitations in conventional incentive systems may also create a burden on the systems of a business entity and/or financial institution that seeks to encourage transactions with a group of potential customers. For example, the business entity and/or the financial institution may be required to display (via a specialized internet web page, for example) the rewards that may be available in return for transacting with the business entity and accumulating incentive “points.” Because such “points” are often proportional to dollar amounts spent at the business entity, the business entity may often be required to expend computing power to calculate and store incentive “points” in uneven denominations or unusable point totals. For example, after redeeming some portion of accumulated incentive “points,” a customer may be left with an unusable point total that is insufficient to purchase and/or exchange for any reward.

Therefore, there exists a need for an improved incentive method, system, and/or device to solve the technical problems outlined above that are associated with conventional incentive systems. More particularly, there exists a need for a method capable of providing notification of transactions with a business entity such that incentives associated with a deposit product serviced by a financial institution in association with the business entity may be received. There also exists a need for an incentive method that provides flexibility to the potential customers to receive points redeemable for a variety of different rewards, arranged in value tiers, corresponding to the transactions between the customer and the business entity. Furthermore, there exists a need for a turn-key incentive method that reduces the burden on a business entity and/or financial institution by: providing a display of available rewards, providing third-party administration of incentive points, detecting transactions (and the assigned values thereof) with the business entity, notifying a financial institution of the number of detected transactions within a transaction period, providing customer service for shipping and/or distributing the rewards, and/or providing other operational support for the incentive system.

### BRIEF SUMMARY OF THE INVENTION

The needs outlined above are met by the present invention which, in various embodiments, provides an incentive method, system, and/or device that overcomes many of the technical problems discussed above, as well other technical problems, with regard to the encouragement of depositing monetary funds in a deposit product serviced by a financial institution, and to the encouragement of transactions between a customer and a business entity.

The above and other needs are met by the present invention which, in one embodiment, provides a method for encouraging a customer to deposit monetary funds in a deposit product serviced by a financial institution. Such a method comprises detecting a plurality of qualified transactions between the customer and at least one participating business entity. Each qualified transaction has an assigned value. The method further comprises determining a total assigned value of the plurality of qualified transactions from the assigned values during a transaction period thereof. Further, the method comprises notifying the financial institution of the total assigned value upon expiration of the transaction period. The financial institution is configured to apply an interest rate to the deposit product associated with the customer in response to the total assigned value received by the financial institution. The interest rate is applied to the deposit product during a reward period, so as to encourage the customer to engage in additional transactions with the at least one business entity. In some embodiments, the method may further comprise issuing a reward credit to the customer in response to the detected at least one qualified transaction. The reward credit has a redemption value corresponding to the at least one transaction, and the reward credit is redeemable in exchange for a reward corresponding to the redemption value of the reward credit, so as to encourage the customer to engage in additional transactions with the at least one business entity.

Another advantageous aspect of the present invention comprises a system for implementing the associated method for encouraging a customer to deposit monetary funds in a deposit product serviced by a financial institution, and, in some instances, for encouraging transactions between a customer and a business entity, as described herein. Such a system may be implemented in computer hardware, software, or a combination of computer software and hardware, having one or more executable and/or processing portions for accomplishing an associated method according to other embodiments of the present invention. In a representative embodiment, a rewards system is at least partially initiated and established on an intermediary computer or computer device, capable of implementing the described associated method, that is part of a larger computer network such as, for example, the Internet. Such an intermediary computer or computer device may comprise, for example, a desktop personal computer, a laptop personal computer, a server, a router, a mainframe computer or like devices or combinations thereof capable of implementing the described functions as known to one skilled in the art. Once established on the intermediary computer or computer device, the rewards system is accessible to a customer (also referred to herein as “user” or “consumer”) via a user's computer device (which also may comprise a part of the rewards system) that is discrete with respect to the intermediary computer or computer device, but capable of communicating with the computer network and, as a result, with the intermediary computer or computer device through, for example, network communication lines.

Various method, system and/or device embodiments of the present invention may also serve to perform administrative and/or service functions with regard to a customer incentive program. For example, some embodiments of the present invention may further comprise presenting the rewards to the customer via a display (such as an internet web page and/or other electronic display) for displaying the reward in a redemption category corresponding to a value of the reward. In some embodiments, the rewards may be arranged and displayed in tiered redemption categories such that as a customer is issued reward credit having a sufficient redemption value, the customer may redeem the reward credit for a reward in one or more of the displayed redemption categories. In addition, some methods, systems and/or devices of the present invention may also comprise shipping the reward to the customer on behalf of the business entity, such that the business entity need not warehouse and/or administer the shipping and/or issuing functions that accompany the customer's redemption of a reward credit. Furthermore, some methods, systems and/or devices of the present invention may also comprise presenting information associated with the detected transactions (or other information related to the detected qualified transactions) to the customer via a display (such as an internet web page and/or other electronic display) for displaying, for example, the number of qualified transactions detected during the transaction period.

Thus the methods, systems, and devices for encouraging a customer to deposit monetary funds in a deposit product serviced by a financial institution, and encouraging transactions between a customer and a business entity, as described in the embodiments of the present invention, provide many advantages that may include, but are not limited to: providing an interest rate incentive system that provides a customer with an interest rate as determined by transactions between the customer and a business entity, providing a tiered incentive and reward system that provides a customer with an instantly redeemable incentive for engaging in a transaction with a business entity; providing a reward credit that may be selectively redeemed for an instant reward and/or stored in a customer account so as to accumulate incentive value that may be later exchanged for a “higher-tier” reward; and providing an incentive method that is turn-key such that a financial institution and business entity associated therewith may focus on their business and/or customer service while the incentive method is administered by a third party that may detect and track the transactions, notify the financial institution of such transactions, present the rewards, and handle customer service issues related to the incentive program.

These advantages and others that will be evident to those skilled in the art are provided in the methods, systems, and devices of the present invention. Importantly, all of these advantages allow a financial institution and/or a business entity to more effectively and efficiently encourage customers to engage in selected transactions therewith.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic representation of a system for encouraging a customer to deposit monetary funds in a deposit product serviced by a financial institution, and for encouraging transactions between a customer and a business entity, according to one embodiment of the present invention;

FIG. 2 is a flow chart of a method according to one embodiment of the present invention including the steps of detecting a plurality of transactions, determining a value associated with the transactions detected during a transaction period, and notifying a financial institution of the value upon expiration of the transaction period;

FIG. 3 illustrates a display according to one embodiment of the present invention wherein a customer may view indicia of business entities participating in an incentive system, wherein the business entities are associated with a financial institution;

FIG. 4 illustrates a display according to one embodiment of the present invention wherein a customer may view options for redeeming and/or adding reward credit to an account balance by submitting information corresponding to a certificate;

FIG. 5 is a flow chart of a method according to one embodiment of the present invention including the steps of detecting a plurality of transactions, determining a value associated with the transactions detected during a transaction period, notifying a financial institution of the value upon expiration of the transaction period, and issuing a reward credit in response to each detected transaction;

FIG. 6 illustrates a display according to one embodiment of the present invention wherein a customer may view an account balance indicating an amount of reward credit associated with a customer account; and

FIG. 7 illustrates a display according to one embodiment of the present invention for displaying the reward in a redemption category corresponding to a value of the reward.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The various aspects of the present invention mentioned above, as well as many other aspects of the invention are described in greater detail below. The methods, systems, and devices of the present invention are described in a banking incentives environment, wherein the incentives are provided by a financial institution associated with at least one business entity, such that the benefits of the methods, systems, and devices may also extend to the at least one business entity. In general, a customer is encouraged to select a deposit product offered by a financial institution, such as a bank, wherein an interest rate is applied to the deposit product for a reward period based upon transactions with a participating business entity during a transaction period. In addition, the customer may also receive, in exchange for the transaction, reward credit that is redeemable as a reward for transacting with the participating business entity. As such, the financial institution benefits by increasing deposits from potential customers, the business entity benefits by increasing sales and revenue, and the customer benefits by controlling the interest rate received on the deposit product, as well as receiving a reward for purchasing products/services from the participating business entity. The methods, systems, and devices of the present invention can be adapted to any number of business entity types (engaging in a number of different transaction types with customers). For example, the present invention may be used to encourage transactions including, but not limited to: initiation of cellular and/or land telephone service with a telecommunications company; transactions via any number of “e-businesses” such as, for example, internet-based payment companies and/or auction sites; transactions with retail stores (via brick-and-mortar locations and/or the Internet); transactions with restaurants.

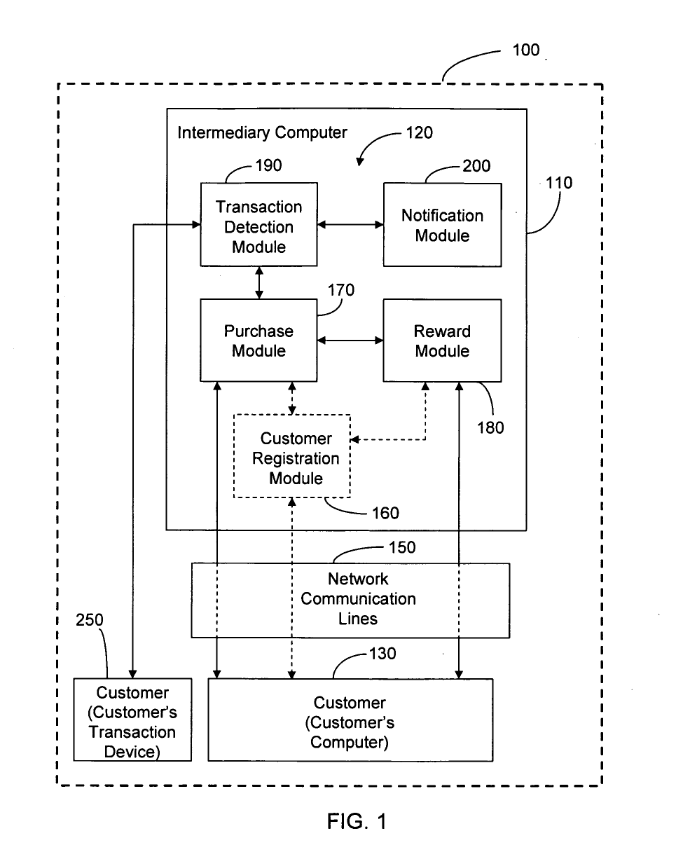

FIG. 1 is a schematic representation of a system, operating over a computer network, for encouraging a customer to deposit monetary funds in a deposit product serviced by a financial institution, and for encouraging transactions between a customer and a business entity, according to one embodiment of the present invention, and is representative of a system capable of implementing a method for encouraging a customer to deposit monetary funds in a deposit product serviced by a financial institution, and for encouraging transactions between a customer and a business entity in accordance with further embodiments of the present invention. The incentive system 120 is initiated, developed, and administered on an intermediary computer or other computer device 110, wherein the intermediary computer or other computer device 110 is part of a larger computer network 100 such as, for example, the Internet. Such an intermediary computer or computer device 110, referred to herein as “intermediary computer 110” for convenience and brevity, may comprise, for example, a desktop personal computer, a laptop personal computer, a server, a router, a mainframe computer or like devices or combinations thereof capable of implementing the functions and methods described herein as will be appreciated by one skilled in the art.

Once established on the intermediary computer 110, the system 120 is accessible to a customer through a customer's computer 130, referred to herein as “customer 130” for convenience and brevity, capable of communicating with the computer network 100 and communicable with the intermediary computer 110 through, for example, network communication lines 150. Note that, while a simple schematic of a single computer device in communication with a computer network is presented herein, it is understood that this concept is representative of communication through an Internet site on, for example, the World Wide Web, and may involve many different computers and associated equipment, wherein the concept of communication via the Internet is known to one skilled in the art. Note that the intermediary computer 110 is typically remote from, discrete, and independent of the customer 130. However, in some instances, embodiments of the system and corresponding method described herein as being performed by the intermediary computer 110 may be hosted by a customer's computer 130, in which case the customer's computer 130 may also serve as the intermediary computer 110 consistent with the spirit and scope of the present invention.

In order to explore the resources offered by the incentive system 120 such as, for example, to purchase goods from a participating business entity, the customer 130 accesses the intermediary computer 110 over the network communication lines 150. Generally associated with the incentive system 120 on the intermediary computer 110 are an optional customer registration module 160, a purchase module 170, a reward module 180, a transaction detection module 190 and a notification module 200. The customer 130 may be, in some instances, required to register with the customer registration module 160 via the network communication lines 150 so as to be able to access and utilize the incentive system 120 and/or execute a transaction through the purchase module 170. In other instances, the customer 130 may not be required to register with the customer registration module 160 until immediately prior to executing a transaction through the purchase module 170. In still other instances, the customer registration module 160 may be an optional component of the system 120, wherein such a system 120 would not require customer registration in order to access the services offered by the system 120. Accordingly, the customer registration module 160 is shown in phantom in FIG. 1 in order to signify the optional nature of the customer registration module 160.

The incentive system 120 is generally implemented in computer software, though the system 120 may also, in some instances, be implemented in a combination of software and hardware. The information gathered through the optional customer registration module 160, the purchase module 170, the reward module 180, and/or the transaction detection module 190 is generally stored in, for example, one or more databases in a memory device (not shown) incorporated within or otherwise associated with the intermediary computer 110. Accordingly, the system 120 may provide data mining opportunities as will be realized by one skilled in the art. Further, the optional customer registration module 160, the purchase module 170, the reward module 180, the transaction detection module 190, and the notification module 200 are typically implemented in computer software, though these components may be implemented by a combination of software and hardware, in some instances. For example, the purchase module 180 may include or be disposed in communication with a router, server, switch, or the like, for appropriately allowing access thereto for listing product prices by a business entity and/or searching and selecting products offered thereby. In addition, the purchase module 170 and/or the reward module 180 may comprise, for instance, a display, a driver, or other mechanism for presenting text, graphics, audio, or the like to display products available for purchase, rewards, or other information associated therewith through the system 120.

Generally, these elements or modules cooperate to form the system 120, implemented in computer software or a combination of software and hardware, including one or more processing portions capable of executing embodiments of a method for encouraging a customer to deposit monetary funds in a deposit product serviced by a financial institution, and for encouraging transactions between a customer and a business entity according to the present invention. Thus, embodiments of such methods according to the present invention may be implemented by one or more corresponding processing portions of an associated system or computer device, wherein each processing portion may comprise a software component, or both a software and hardware component, capable of implementing one or more of the specified functions. An associated computer software program product may also be provided, wherein such a computer software program product may include one or more executable portions capable of being executed by an appropriate computer device to perform any or all of the methods described herein. Accordingly, the operation of the incentive system 120 and its associated elements may be more particularly illustrated from the description of an associated method corresponding to one embodiment of the present invention.

In addition to providing methods, systems, and devices, the present invention also provides computer program products for performing the operations described above. The computer program products have a computer readable storage medium having computer readable program code means embodied in the medium. The computer readable storage medium may be part of a storage device and may implement the computer readable program code means to perform the above discussed operations.

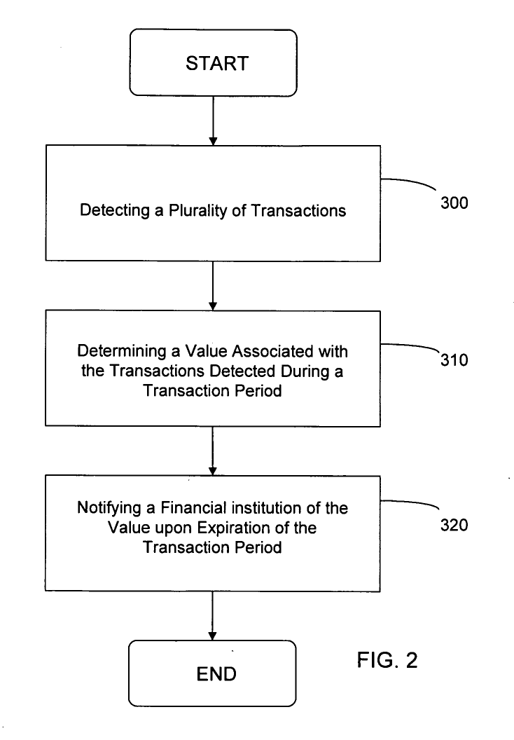

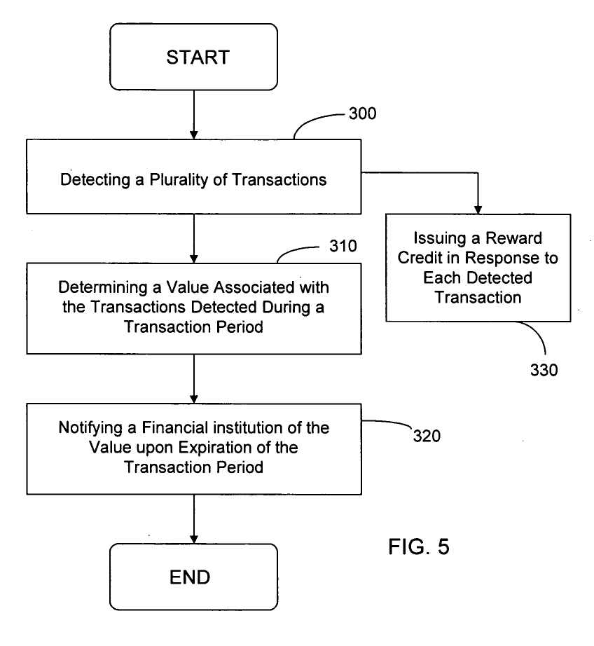

In this regard, FIGS. 2 and 5 are block diagram illustrations of methods, systems, and devices according to the invention. It will be understood that each block or step of the block diagram and combinations of blocks in the block diagram can be implemented by computer program instructions. These computer program instructions may be loaded onto a computer device or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer device or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer device or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

FIG. 2 illustrates a flow chart depicting a method according to one embodiment of the present invention for encouraging a customer to deposit monetary funds in a deposit product serviced by a financial institution. The method may comprise, for example, step 300 for detecting a plurality of qualified transactions between a customer and at least one business entity associated with a financial institution; step 310 for determining a value associated with the transactions detected during a transaction period; and step 320 for notifying the financial institution of the value upon expiration of the transaction period, such that an interest rate may be applied by the financial institution to the deposit product in response to the detected qualified transactions. Thus, the method embodiments of the present invention may further encourage the customer to engage in additional transactions with the business entity in order to receive a maximum interest rate on the deposit product.

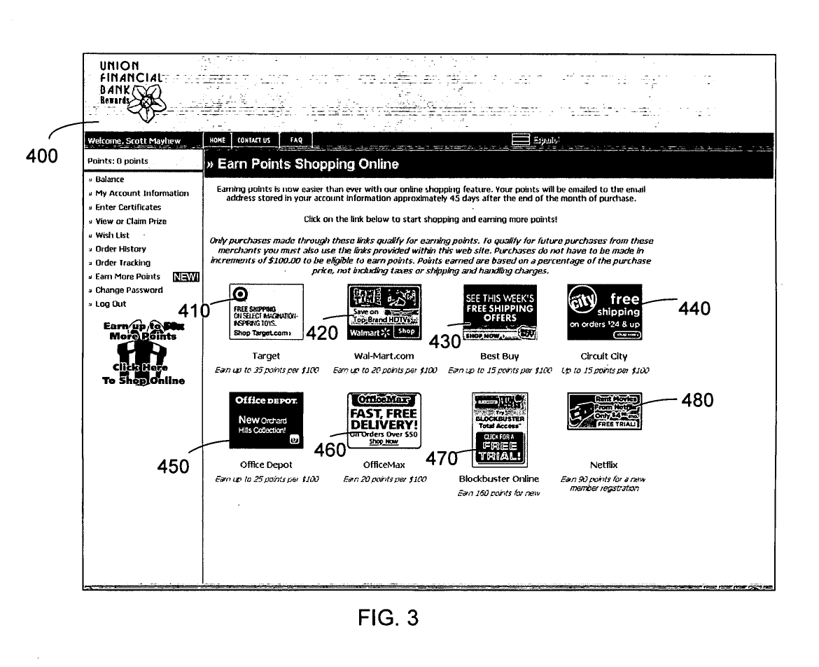

The detecting step 300 may comprise in one embodiment, for example, monitoring a business entity internet website for transaction activity between a customer (which may be identified by a unique customer identifier, such as a customer identification number, password, or other identification) and the business entity. According to some embodiments, the detecting step 300 may be performed by a computer device in communication via wired and/or wireless networks (such as the Internet) with a computer device operated by the business entity. In other instances, the customer may access the business entity internet website via an internet website hosted by a computer device operated by the financial institution and/or a third-party, wherein the customer may “click-through” therethrough to access the business entity internet website. In this manner, the transactions between the customer and the business entity may be detected and tracked by the financial institution and/or the third-party. For example, FIG. 3 illustrates an internet website displayed on a display device such that the customer is capable of identifying business entities participating in the incentive system 120. Further, by accessing the internet website of the business entity from the internet website for the incentive system, the customer's purchases may be detected and tracked for determining the interest rate to be applied to the deposit product and, in some instances, providing reward credit to the customer. Thus, according to some embodiments of the present invention, the customer may access the various participating business entities for transacting therewith via an Internet website configured to present a display 400 shown generally in FIG. 3 such that the customer may transact with any one of the business entities 410-480 shown in the display 400. According to some method, system, and device embodiments of the present invention, the display 400 shown generally in FIG. 3 may also display the business entities 410-480 as interactive graphics that may be selected (i.e., by the click of a mouse), causing the display 400 to direct the customer to the home Internet website of the business entity, as understood by those of skill in the art.

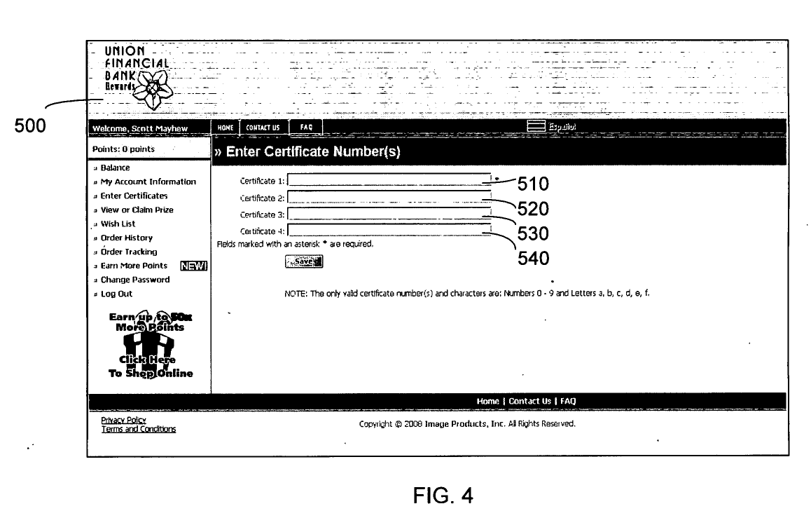

Furthermore, in other embodiments, the detecting step 300 may be performed by detecting a certificate received by the customer from the business entity. That is, in exchange for transacting with the business entity, the customer may be provided with a certificate which may be exchange for reward credit, such as described in U.S. Patent Publication No. 2007/0078710 to Bender, which is incorporated herein by reference in its entirety. In one instance, the certificate may include a unique indicia thereon (e.g., a serial number) which can be entered via an internet website, such as, for example, the internet website associated with the incentive system 120, such that information associated with the certificate is submitted to the financial institution and/or the third-party, as shown in FIG. 4. Thus, according to some embodiments of the present invention, the customer may enter the information associated with the certificate such that transactions may be detected, wherein the certificate information is entered via an Internet website configured to present a display 500 having entry fields 510-540, as shown generally in FIG. 4. In this regard, a transaction between the customer and the business entity may be detected and tracked through redemption of the certificate. The certificates may be distributed to the business entity via various methods, which may include, but are not limited to: issuing the certificate via an electronic mail message; printing a paper copy of the certificate that may be given directly and/or mailed to the customer; displaying the certificate to a customer via a display screen; and other issuing methods. For example, the business entity may request certificates for an event in which the business entity markets the event by promoting the certificates. In one instance, the certificates may be issued to a computer device operated by the business entity (via, for example, a wired and/or wireless network (such as the Internet)) such that the intermediary computer device 110 sends certificates via electronic mail and/or via facsimile or other method, directly to the business entity such that a representative and/or employee of the business entity may present the customer with the certificate at the physical location of the transaction (such as at the business entity's offices and/or storefront).

In addition, in other embodiments, the detecting step 300 may be performed by detecting a plurality of qualified transactions through identification of an association between the customer and the financial institution during each qualified transaction with the business entity. For example, transactions between the customer and the business entity may be detected through use of a customer transaction device 250 (e.g., a debit card) by the customer, as shown in FIG. 1. In some instances, the customer transaction device 250 may be provided by the financial institution and associated with the deposit product to which the interest rate incentive program is applied. For example, a debit card associated with the interest rate incentive-based deposit product (i.e., the deposit product to which the earned interest rate is applied) or other deposit product (i.e., a deposit product held with the financial institution offering the interest rate incentive-based deposit product, but not being itself incentive based) may be provided to the customer such that transactions with participating business entities may be detected. That is, the customer uses the debit card to pay for the products/services offered by the participating business entity, wherein the debit card is associated with a deposit product held by the financial institution offering the interest rate incentive-based deposit product such that the information is transmitted electronically to the financial institution in order to take action against the account, as known by those of ordinary skill in the art. In this regard, the transaction information may be also transmitted to a third party, from the business entity and/or the financial institution, for detecting and tracking the transactions. In other instances, the transactions may be detected by a customer using its customer transaction device 250 in a non-payment manner. For example, grocery stores often provide customers with non-payment customer transaction devices 250 designed to create loyalty thereto. That is, a customer may present a cashier of the grocery store with the customer transaction device 250 at the time of payment such that the customer is rewarded a discount on the current purchases. In this manner, such a non-payment customer transaction device 250 provided by a participating business entity may also be used to detect transactions between the business entity and the customer. Such transaction information may then be appropriately directed to a computer device or other system detecting and/or tracking transactions eligible for consideration in the incentive system described herein.

In aspects of the incentive system described herein, the detected transactions are referred to as qualifying transactions. In this regard, the transaction may need to meet certain requirements, standards, or other criteria as may be set forth by the financial institution and/or the business entity in order to be considered a qualified transaction and, thus, included in calculating the interest rate for the deposit product and/or the reward credit to be received. In one example, each transaction between the customer and business entity may be counted as a qualified transaction, with no regard to the amount of money spent or products purchased. One of ordinary skill in the art will recognize that, in some instances, the transaction may only be considered a qualified transaction when a minimum amount of money is spent by the customer and/or when a minimum number of items are purchased.

In accordance with embodiments of the present invention, each qualified transaction may be assigned a value such that the transactions between the customer and participating business entities may be tracked. In one instance, the assigned value may be associated with each transaction on a one-to-one basis such that each qualified transaction receives a count of one as the assigned value. For example, if the customer transacts in a qualifying manner with a participating business entity 10 times, then the customer would receive credit for 10 transactions that may be applied to the interest rate incentive system. In other instances, the assigned value may correspond to any other counting/value method capable of being configured for corresponding to the interest rate incentive system 120.

The determining step 310 may comprise in one embodiment, for example, determining the total number of qualified transactions between the customer and the participating business entities, with regard to the qualified transactions detected in any manner previously described or otherwise. For example, the intermediary computer device 110 may detect 5 qualified transactions with a first business entity and 10 qualified transactions with a second business entity, wherein each qualified transaction is assigned a value such that a total value may be determined. In this instance, the total value associated with transactions would be 15 total qualified transactions. The total assigned value is determined over a transaction period. That is, the qualified transactions are detected and/or tracked during a set interval of time (the transaction period) such that the total assigned value is associated with the transaction period. In most instances, it may be relatively simple to detect the qualified transactions during the transaction period, such as, for example, when a customer transaction device is used during the transaction and/or the product/service is purchased over an internet website provided by the business entity. In other instances, the transaction may be detected outside of the actual transaction period, such as, for example, when a certificate is redeemed on an internet website after the transaction period in which the certificate was received expires. In such instances, the qualified transaction and assigned value may be applied to the current transaction period (i.e., the transaction period during which the certificate is redeemed). In other instances, the transaction may be determined to be detected during the actual transaction period (i.e., the transaction period in which the transaction occurred), even with the use of certificates redeemed outside the transaction period. In one particular example, the transaction period may be defined as a calendar month. One of ordinary skill in the art, however, will recognize that the transaction period could be defined as any period of time.

The notifying step 320 may comprise in one embodiment, for example, electronically transmitting upon expiration of the transaction period the total assigned value to the financial institution from, for example, a third-party administering the incentive system 100. In some instances, this may be accomplished via the intermediary computer device 110 transmitting the total assigned value to the financial institution via the network 150. In other instances, the assigned values corresponding to the individual qualified transactions may be transmitted to the financial institution, rather than only the total assigned value. In other embodiments, the total assigned value may be communicated or otherwise provided to the financial institution in any suitable manner. For example, in some instances, the intermediary computer device 110 may be operated and controlled by the financial institution such that the transactions are directly detected by the financial institution. In such instances, the total assigned values may also be directly determined thereby and the notification may occur by displaying the total assigned value on a display device such that it can be used to determine the appropriate interest rate incentive to which the customer is entitled.

By notifying the financial institution of the total assigned value, an interest rate may be determined and applied to the deposit product associated with the customer, in response to the detected qualified transaction during the transaction period. In one particular example, an interest rate scheme for a deposit product offered by the financial institution to entice customers to transact therewith may be applied based on the qualified transactions detected during the transaction period. The interest rate scheme may be applied to the deposit product during a reward period. The reward period may be defined as any set interval of time such as, for example, a calendar month. In some instances, the reward period may begin immediately following the expiration of the transaction period. In other instances, the reward period may begin at any point in time and could also be applied retroactively (i.e., to a previous reward period). In any event, the customer is encouraged to engage in additional transactions with the business entity/entities so as to receive an increased interest rate on the deposit product serviced by the financial institution.

The interest rate scheme applied to the deposit product associated with the customer may be configured in any suitable manner. For example, in one instance, the customer may receive a base interest rate in return for selecting a deposit product offered by the financial institution. In such instance, the base interest rate may be applied to the deposit product regardless of the number of purchases transacted between the customer and participating business entities. In this manner, the customer may receive at least the base interest rate on the deposit product for each reward period (e.g., receiving a 2% base interest rate per month). As such, any interest rate earned from transacting with participating business entities may be applied to the base interest rate during the reward period. That is, the interest rate associated with the deposit product may increase or receive a “bump” from the base interest rate (e.g., the customer has earned a 1% interest rate increase through the incentive system to be applied to a 2% base interest rate, resulting in a 3% total interest rate to be applied to the deposit product during the reward period).

In other embodiments, the interest rate to be applied to the deposit product during the reward period may be entirely dependent upon the total assigned value determined from the qualified transactions occurring during the transaction period, wherein no base interest rate is associated with the deposit production. For example, the financial institution may be notified that 10 qualified transactions had been detected during the transaction period, wherein the interest rate scheme is configured such that each 5 qualifying transactions detected during the transaction period results in a 0.5% interest rate being applied to the deposit product. Thus, in this particular example, the customer would receive a 1% interest rate applied to the deposit product during the reward period. In this regard, there may be instances where no interest rate is applied to the deposit product during a reward period (i.e., no qualifying transactions were completed during the transaction period or otherwise an insufficient quantity of qualifying transactions).

In any event, the interest rate earned/received through the incentive method may be “capped” such that only a maximum interest rate is capable of being achieved during the reward period (e.g., the interest rate may not exceed 5% during the reward period). In such instances, any excess interest rate earned may or may not be carried over into subsequent reward periods. Further, the deposit balance to which the rate applies also may be “capped” such that a maximum amount may exist upon which the interest rate may be applicable.

Having now described the incentive system for encouraging a customer to deposit monetary funds with a financial institution, an exemplary incentive method, system, and device in accordance with embodiments of the present invention will now be provided. In one example, the customer may select a deposit product serviced by the financial institution, wherein the customer receives a 0.5% interest rate for every 10 qualifying transactions transacted and detected during each month (i.e., the transaction period) with a business entity associated with the financial institution (i.e., participating in the incentive system), up to a maximum 5% interest rate. The earned interest rate would be applied for a month (i.e., the reward period) following expiration of the transaction period (i.e., subsequent to the transaction month). If, for example, the customer, during the transaction period, used a customer transaction device during 7 qualified transactions, completed 15 qualified transactions via a business entity internet website, and redeemed 2 certificates via an internet website hosted by a third-party administering the incentive system, then 24 qualified transactions would be detected by the intermediary computer device 120, with each qualified transaction having an assigned value of one such that the total assigned value is twenty-four. In this regard, the financial institution is notified of the total assigned value and determines that an interest rate of 1% is to be applied to the deposit product associated with the customer. As such, the customer is encouraged to select the deposit product offered by the financial institution because of the possibility of receiving interest rates higher than available at other financial institutions. Further, the customer is encouraged to transact with the participating business entities. Of course, one of ordinary skill in the art will recognize that interest rate scheme and other variables associated with this example may be altered to suitable preferences by the customer, financial institution, and/or participating business entity/entities, and such an example is not meant to limit the disclosure herein in any manner.

In some embodiments, the participating business entity/entities may provide a rebate to the financial institution, either directly or indirectly (such as through a third-party administrator), to assist in offsetting the increased interest rates offered to the customer, in return for directing the customer to transact with the business entity. In some instances, the rebate may be generally calculated as a percentage of sales associated with the qualified transactions detected for a given participating business entity. In this manner, the financial institution may receive an additional revenue stream from such rebates, while the participating business entity receives increased revenue from customers transacting therewith in an effort to receive an increased interest rate on a deposit product serviced by the financial institution. Furthermore, the financial institution is able to attract more deposits of monetary funds by offering a higher interest rate than competitor banks. Furthermore, the business entity/entities may provide rebates to a third-party administrator for administering embodiments of the present invention. In addition, the third-party administrator may sell the certificates described previously to the participating business entities to assist in funding the incentive system.

In an alternative embodiment, as illustrated in the flow chart of FIG. 5, the previously described method may further include step 330 for issuing a reward credit in response to the detected qualified transaction(s). In some instances, the reward credit may be accumulated and exchanged for a reward having value commensurate and/or proportional to the detected qualified transactions. Thus, the method embodiments of the present invention may encourage the at least one customer to engage in additional transactions with the business entity in order to gain additional reward credits that may be redeemable for one or more rewards, in addition to receiving an increased interest rate associated with a deposit product during a reward period, as previously discussed herein. That is, according to some embodiments of the present invention, such an award of a reward credit having a redemption value may encourage the customer to engage in further qualifying transactions in the hope of earning more reward credits that may be redeemed for one or more of a wide selection of reward items (as described in further detail below).

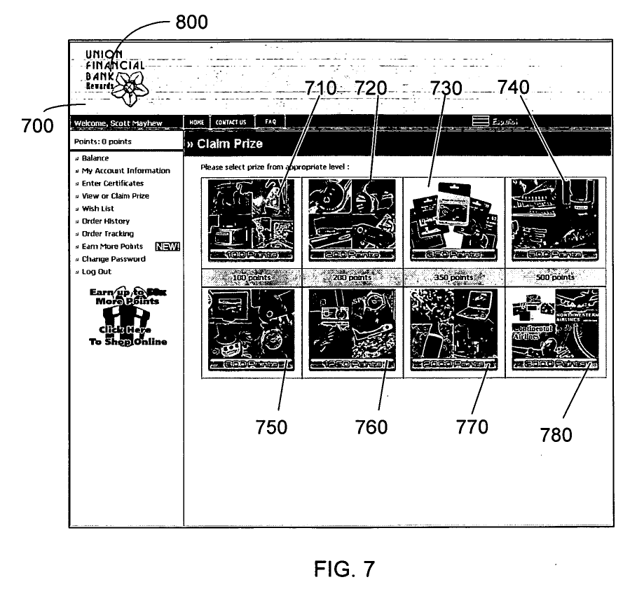

In some method embodiments, the value of the qualifying transaction may be pre-assigned by the business entity such that the amount of reward credit issued has a greater redemption value in return for detected transactions that result in greater profit and/or a more desirable outcome for the business entity. For example, in embodiments where the business entity is a retail store, the retail store may assign reward credit for a transaction as determined by the total purchase price of products/services purchases by the customer. According to some embodiments, the issuing step may comprise issuing a reward credit having a redemption value of 100 points, for example, when a customer spends a minimum monetary sum with the retail store during a single transaction. In another example, the issuing step may comprise issuing a reward credit having a redemption value of 500 points, for example, when a customer dines at a participating restaurant and spends a minimum monetary sum. Thus, the business entity may encourage additional transactions and/or transactions that may be more profitable by providing reward credit to the transaction types that may be detected in step 300 and issuing reward credit with redemption values that are proportional to the profit and/or desirability of the transaction types detected. Further, the issued reward credit may be variable based on the total money spent during a transaction (e.g., receiving a predetermined amount of reward credit per $100 spent). In some instances, the reward credit may be instantly and singularly redeemable in exchange for a reward corresponding to the redemption value of the reward credit, so as to encourage the customer to engage in additional transactions with the business entity. For example, the retail store customer described above may be able to redeem the 100 point reward credit immediately for one of the rewards that may be displayed (see the display 700 of FIG. 7) in a 100 point reward category 710.

In another exemplary method embodiment of the present invention, the method further comprises a receiving step for receiving the reward credit from the customer (i.e., the customer redeeming the reward credit), and an issuing step for issuing a reward in exchange for the reward credit. According to one embodiment of the present invention, the method of the present invention may also comprise a presenting step, for presenting a reward to the customer via the display 700 (see FIG. 7, for example, depicting an Internet webpage that may be accessed by a customer according to one embodiment of the present invention, for viewing rewards that may be obtained by redeeming reward credits).

The display 700 may, in some embodiments (as shown generally in FIG. 7, present the reward to the customer in a redemption category (see elements 910-960) corresponding to the value of the reward. Thus, according to some embodiments of the present invention, the customer may access the various reward redemption categories via an Internet website configured to present the display 700 shown generally in FIG. 7 such that the customer may instantly redeem reward credit (having a specific redemption value) for a reward in one of the categories 710-780 shown in the display 700. For example, if the customer has been issued a reward credit having a redemption value of 500 points, the customer may choose to instantly redeem the reward credit for one of the items listed within the 500 point redemption category 740 in the display. According to some method, system, and device embodiments of the present invention, the display 700 shown generally in FIG. 7 may also display the redemption categories 710-780 as interactive graphics that may be selected (i.e., by the click of a mouse), causing the display 700 to update to a detailed list and/or description of reward items that the customer may choose to be issued. According to various embodiments of the present invention, the issuing step may comprise initiating a shipping step and/or a contacting step. In addition, according to some embodiments, the issuing step may also initiate (either automatically via computer program product embodiments of the present invention, or via substantially manual methods, such as the generation of a warehouse “pick sheet” or order sheet) a step for notifying a warehouse and/or third-party logistic service of the customer's shipping address and/or other information that may assist in the issuance of the reward in return for the reward credit. For example, once the customer has selected a reward and initiated the receiving step, methods of the present invention, as part of the issuing step, may comprise automatically notifying a third-party (responsible for storing and/or shipping the various rewards) that the selected reward should be shipped to the customer. Such a notification may be performed in an automated manner according to some computer program embodiments of the present invention as part of the issuing, shipping, and/or contacting steps.

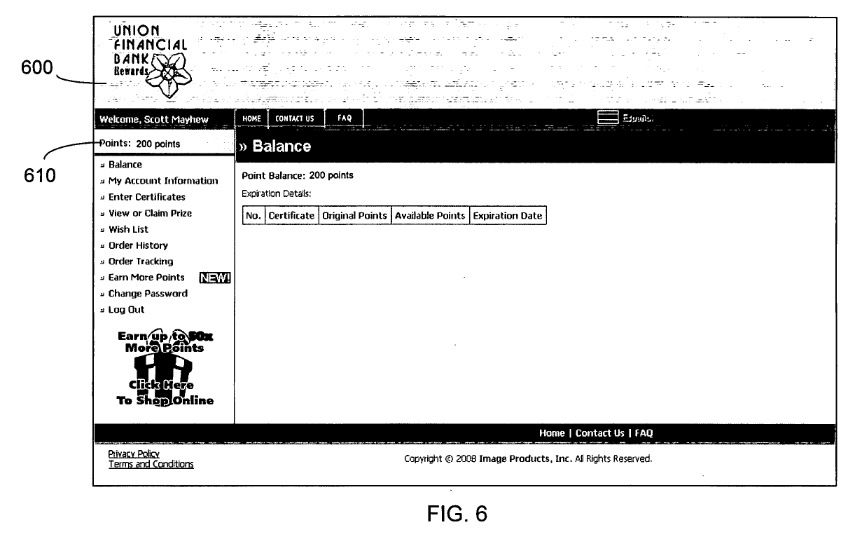

The method of the present invention also provides additional alternate embodiments wherein a customer may choose to save multiple reward credits and accumulate the redemption values of the reward credits in an account balance that may be received (in its entirety, or in discrete portions) and/or redeemed for rewards having a greater value than the redemption value of any single reward credit. For example, as shown in FIG. 6, the method, system, and device embodiments of the present invention may further comprise adding/crediting the redemption value of the reward credit to an account balance corresponding to the customer such that the account balance may accumulate the redemption value of the reward credit. According to some method, system, and device embodiments of the present invention, the crediting step may be displayed via an internet website and/or computer display 600 (as shown in FIG. 6, for example) such that the customer may accumulate the reward credits in an account balance 610 that may be maintained according to various embodiments of the present invention, in a computer device, such as a server and/or personal computer that may be selectively accessed by the customer via an internet portal and/or via a computer display 600 (as shown generally in FIG. 6) which may be provided to facilitate some of the method steps of the present invention.

Thus, according to one example of the receiving and adding steps of the present invention, the method may comprise receiving reward credit for four qualified transactions, each having a redemption value of 200 points (which may have been issued to the customer in return for engaging in four separate transactions) and adding the redemption values of the reward credits to accumulate an account balance 610 of 800 points. Thus, the present invention may also enable the customer to select and redeem the account balance 610 for a reward in the 800 point redemption category (see element 750 of FIG. 7) instead of 4 individual rewards in the 200 point reward category (see element 720 of FIG. 7).

In another alternate method embodiment of the present invention, the method further comprises receiving a redemption request from the customer (the redemption request corresponding to a portion of the account balance 610 accumulated, for example), and issuing the reward in return for the portion of the account balance 610. An issuing step may also comprise initiating a shipping step and/or a shipping and issuing confirmation step. In addition, according to some embodiments, the issuing step may also initiate (either automatically via electronic notification and/or computer program product embodiments of the present invention, or via substantially manual methods, such as the generation of a warehouse “pick sheet” or order) a step for notifying a warehouse and/or third-party logistic service of the customer's shipping address and/or other information that may assist in the issuance of the reward in return for the redemption of at least a portion of the accumulated account balance 610.

Various method and computer program product embodiments of the present invention may also provide a “turn-key” incentive program for a financial institution to encourage depositing monetary funds therewith, and to encourage one or more transactions between a customer and the business entity. For example, in some embodiments, the presenting step may comprise presenting the rewards to a customer via an internet website and/or other visual display 700 that includes a logo, color scheme, background, trademarks, and/or trade dress (e.g., logo 800) that represents the financial institution. Furthermore, according to some embodiments some or all of the rewards issued may also be imprinted directly with and/or shipped in packing material including a logo, color scheme, background, trademarks, and/or trade dress representing the financial institution. Thus, the methods of the present invention may be performed by a third party provider on behalf of the financial institution and/or participating business entity/entities such that the customer may be exposed only to the financial institution (instead of the third-party provider) and also such that the financial institution need not be involved with the operation and/or administration of the methods, systems, and devices of the present invention.

For example, some method, system, and/or device embodiments of the present invention may comprise shipping the reward to the customer on behalf of the financial institution. Furthermore, according to some embodiments, as described generally above, the method of the present invention may also comprise notifying a logistic service provider (such as a warehousing and/or shipping entity) when some portion of an account balance 610 has been received and/or redeemed by a customer. Such a notification may include, but is not limited to: the identification of a specific reward, the customer identification and/or shipping address, special shipping instructions, and/or the financial institution on whose behalf the reward is being shipped. Thus, the operator performing the steps of the present invention may select packing materials, literature, and/or specific reward types that correspond to a given financial institution.

In addition, some embodiments of the present invention may also comprise contacting the customer to confirm the issuing and shipping of the reward. For example, the methods and/or computer program products of the present invention may prompt customer service personnel to provide a follow-up telephone call to the customer to ensure that the appropriate reward was received by the customer and/or that shipping of the reward occurred within a promised and/or expected time frame. Furthermore, according to some other embodiments, the contacting step may also comprise generating an automated and/or semi-automated message (which may include, for example, an electronic mail message) to the customer to confirm accuracy and promptness of the issuing and shipping of the reward.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An intermediary computer device configured to implement a system for encouraging a customer to deposit monetary funds in a deposit product serviced by a financial institution, the intermediary computer device being configured to be in communication with a computer network so as to be capable of communicating with a discrete computer device adapted to be used by the customer, said intermediary computer device comprising:
a processing portion for detecting a plurality of qualified transactions between the customer and at least one business entity associated with the financial institution, each qualified transaction having an assigned value;
a processing portion for determining a total assigned value of the plurality of qualified transactions from the assigned values during a transaction period thereof; and
a processing portion for notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period, so as to encourage the customer to engage in additional transactions with the at least one business entity.

2. An intermediary computer device according to claim 1 wherein the processing portion for detecting a plurality of qualified transactions is further configured to identify an association between the customer and the financial institution during each qualified transaction with the at least one business entity.

3. An intermediary computer device according to claim 2 wherein the processing portion for identifying an association is further configured to at least one of:
identify transactions between the customer and the at least one business entity during transactions conducted over a computer network system; and
identify transactions between the customer and the at least one business entity during transactions transacted using a customer transaction device associated with the financial institution and the deposit product.

4. An intermediary computer device according to claim 1 wherein the processing portion for detecting a plurality of qualified transactions is further configured to detect a qualified transaction facilitated by the discrete computer device.

5. An intermediary computer device according to claim 1 wherein the processing portion for notifying the financial institution is further configured to identify transactions between the customer and the at least one business entity by determining redemption of at least one certificate issued to the customer by the at least one business entity in response to a transaction therebetween.

6. An intermediary computer device according to claim 1 wherein the processing portion for determining a total assigned value is further configured to determine a total number of transactions transacted between the customer and the at least one business entity during the transaction period such that the total number of transactions during the transaction period corresponds to the interest rate applied to the deposit product during the reward period.

7. An intermediary computer device according to claim 1 wherein the processing portion for notifying the financial institution is further configured to notify the financial institution of the total assigned value upon expiration of the transaction period, the financial institution being configured to provide the customer with a base interest rate associated with the deposit product upon selection thereof, the interest rate being added to the base interest rate so as to provide an increased interest rate during the reward period.

8. An intermediary computer device according to claim 1 wherein the processing portion for notifying the financial institution is further configured to notify the financial institution of the total assigned value upon expiration of the transaction period such that the interest rate is capable of being calculated according to an interest rate scheme associated with the deposit product.

9. A system for encouraging a customer to deposit monetary funds in a deposit product serviced by a financial institution, said system comprising:
a first computer device configured to be in communication with a computer network, the first computer device comprising:
a processing portion for detecting a plurality of qualified transactions between the customer and at least one business entity associated with the financial institution, each qualified transaction having an assigned value;
a processing portion for determining a total assigned value of the plurality of qualified transactions from the assigned values during a transaction period thereof; and
a processing portion for notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period, so as to encourage the customer to engage in additional transactions with the at least one business entity.

10. A system according to claim 9 wherein the processing portion for detecting a plurality of qualified transactions is further configured to identify an association between the customer and the financial institution during each qualified transaction with the at least one business entity.

11. A system according to claim 10 wherein the processing portion for identifying an association is further configured to at least one of:
identify transactions between the customer and the at least one business entity during transactions conducted over a computer network system; and
identify transactions between the customer and the at least one business entity during transactions transacted using a customer transaction device associated with the financial institution and the deposit product.

12. A system according to claim 9 further comprising a second computer device adapted to be used by the customer and configured to be capable of communicating with the computer network, so as to be capable of communicating with the first computer device, the second computer device comprising:
a processing portion for facilitating a qualified transaction between the customer and the at least one business entity, each qualified transaction facilitated thereby being detected by the first computer device.

13. A system according to claim 9 wherein the processing portion for notifying the financial institution is further configured to identify transactions between the customer and the at least one business entity by determining redemption of at least one certificate issued to the customer by the at least one business entity in response to a transaction therebetween.

14. A system according to claim 9 wherein the processing portion for determining a total assigned value is further configured to determine a total number of transactions transacted between the customer and the at least one business entity during the transaction period such that the total number of transactions during the transaction period corresponds to the interest rate applied to the deposit product during the reward period.

15. A system according to claim 9 wherein the processing portion for notifying the financial institution is further configured to notify the financial institution of the total assigned value upon expiration of the transaction period, the financial institution being configured to provide the customer with a base interest rate associated with the deposit product upon selection thereof, the interest rate being added to the base interest rate so as to provide an increased interest rate during the reward period.

16. A system according to claim 9 wherein the processing portion for notifying the financial institution is further configured to notify the financial institution of the total assigned value upon expiration of the transaction period such that the interest rate is capable of being calculated according to an interest rate scheme associated with the deposit product.

17. A method for encouraging a customer to deposit monetary funds in a deposit product serviced by a financial institution, the method comprising:
detecting a plurality of qualified transactions between the customer and at least one business entity associated with the financial institution, each qualified transaction having an assigned value;
determining a total assigned value of the plurality of qualified transactions from the assigned values during a transaction period thereof; and
notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period, so as to encourage the customer to engage in additional transactions with the at least one business entity.

18. A method according to claim 17 wherein detecting a plurality of qualified transactions comprises identifying an association between the customer and the financial institution during each qualified transaction with the at least one business entity.

19. A method according to claim 18 wherein identifying an association further comprises at least one of:
identifying transactions between the customer and the at least one business entity during transactions conducted over a computer network system; and
identifying transactions between the customer and the at least one business entity during transactions transacted using a customer transaction device associated with the financial institution and the deposit product.

20. A method according to claim 17 wherein notifying the financial institution comprises identifying transactions between the customer and the at least one business entity by determining redemption of at least one certificate issued to the customer by the at least one business entity in response to a transaction therebetween.

21. A method according to claim 17 wherein determining a total assigned value further comprises determining a total number of transactions transacted between the customer and the at least one business entity during the transaction period such that the total number of transactions during the transaction period corresponds to the interest rate applied to the deposit product during the reward period.

22. A method according to claim 17 wherein the financial institution is further configured to provide the customer with a base interest rate associated with the deposit product upon selection thereof, the interest rate being added to the base interest rate so as to provide an increased interest rate during the reward period.

23. A method according to claim 17 wherein notifying the financial institution further comprises notifying the financial institution such that the interest rate is capable of being calculated according to an interest rate scheme associated with the deposit product.

24. An intermediary computer device configured to implement a system for encouraging a customer to deposit monetary funds in a deposit product serviced by a financial institution, and encouraging transactions between a customer and a business entity, the intermediary computer device being configured to be in communication with a computer network so as to be capable of communicating with a discrete computer device adapted to be used by the customer, said intermediary computer device comprising:
a processing portion for detecting a plurality of qualified transactions between the customer and at least one business entity associated with the financial institution, each qualified transaction having an assigned value;
a processing portion for determining a total assigned value of the plurality of qualified transactions from the assigned values during a transaction period thereof;
a processing portion for notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period, so as to encourage the customer to engage in additional transactions with the at least one business entity; and
a processing portion for issuing a reward credit to the customer in response to the detected at least one qualified transaction, the reward credit having a redemption value corresponding to the at least one transaction, the reward credit being redeemable in exchange for a reward corresponding to the redemption value of the reward credit, so as to encourage the customer to engage in additional transactions with the at least one business entity.

25. An intermediary computer device according to claim 24 wherein the processing portion for detecting a plurality of qualified transactions is further configured to identify an association between the customer and the financial institution during each qualified transaction with the at least one business entity.

26. An intermediary computer device according to claim 25 wherein the processing portion for identifying an association is further configured to at least one of:
identify transactions between the customer and the at least one business entity during transactions conducted over a computer network system; and
identify transactions between the customer and the at least one business entity during transactions transacted using a customer transaction device associated with the financial institution and the deposit product.

27. An intermediary computer device according to claim 24 wherein the processing portion for detecting a plurality of qualified transactions is further configured to detect a qualified transaction facilitated by the discrete computer device.

28. An intermediary computer device according to claim 24 wherein the processing portion for notifying the financial institution is further configured to identify transactions between the customer and the at least one business entity by determining redemption of at least one certificate issued to the customer by the at least one business entity in response to a transaction therebetween.

29. An intermediary computer device according to claim 24 wherein the processing portion for determining a total assigned value is further configured to determine a total number of transactions transacted between the customer and the at least one business entity during the transaction period such that the total number of transactions during the transaction period corresponds to the interest rate applied to the deposit product during the reward period.

30. An intermediary computer device according to claim 24 wherein the processing portion for notifying the financial institution is further configured to notify the financial institution of the total assigned value upon expiration of the transaction period, the financial institution being configured to provide the customer with a base interest rate associated with the deposit product upon selection thereof, the interest rate being added to the base interest rate so as to provide an increased interest rate during the reward period.

31. An intermediary computer device according to claim 24 wherein the processing portion for notifying the financial institution is further configured to notify the financial institution of the total assigned value upon expiration of the transaction period such that the interest rate is capable of being calculated according to an interest rate scheme associated with the deposit product.

32. An intermediary computer device according to claim 24 further comprising:
a processing portion for receiving the reward credit from the customer; and
a processing portion for adding the reward credit to an account balance corresponding to the customer such that the account balance is capable of accumulating the redemption value of the reward credit.

33. An intermediary computer device according to claim 24 further comprising a processing portion for presenting the reward to the customer via a display device for displaying the reward in a redemption category corresponding to a value of the reward.

34. A system for encouraging a customer to deposit monetary funds in a deposit product serviced by a financial institution, and encouraging transactions between a customer and a business entity, said system comprising:
a first computer device configured to be in communication with a computer network, the first computer device comprising:
a processing portion for detecting a plurality of qualified transactions between the customer and at least one business entity associated with the financial institution, each qualified transaction having an assigned value;
a processing portion for determining a total assigned value of the plurality of qualified transactions from the assigned values during a transaction period thereof;
a processing portion for notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period, so as to encourage the customer to engage in additional transactions with the at least one business entity; and
a processing portion for issuing a reward credit to the customer in response to the detected at least one qualified transaction, the reward credit having a redemption value corresponding to the at least one transaction, the reward credit being redeemable in exchange for a reward corresponding to the redemption value of the reward credit, so as to encourage the customer to engage in additional transactions with the at least one business entity.

35. A system according to claim 34 wherein the processing portion for detecting a plurality of qualified transactions is further configured to identify an association between the customer and the financial institution during each qualified transaction with the at least one business entity.

36. A system according to claim 35 wherein the processing portion for identifying an association is further configured to at least one of:
identify transactions between the customer and the at least one business entity during transactions conducted over a computer network system; and
identify transactions between the customer and the at least one business entity during transactions transacted using a customer transaction device associated with the financial institution and the deposit product.

37. A system according to claim 34 further comprising a second computer device adapted to be used by the customer and configured to be capable of communicating with the computer network, so as to be capable of communicating with the first computer device, the second computer device comprising:
a processing portion for facilitating a qualified transaction between the customer and the at least one business entity, each qualified transaction facilitated thereby being detected by the first computer device.

38. A system according to claim 34 wherein the processing portion for notifying the financial institution is further configured to identify transactions between the customer and the at least one business entity by determining redemption of at least one certificate issued to the customer by the at least one business entity in response to a transaction therebetween.

39. A system according to claim 34 wherein the processing portion for determining a total assigned value is further configured to determine a total number of transactions transacted between the customer and the at least one business entity during the transaction period such that the total number of transactions during the transaction period corresponds to the interest rate applied to the deposit product during the reward period.

40. A system according to claim 34 wherein the processing portion for notifying the financial institution is further configured to notify the financial institution of the total assigned value upon expiration of the transaction period, the financial institution being configured to provide the customer with a base interest rate associated with the deposit product upon selection thereof, the interest rate being added to the base interest rate so as to provide an increased interest rate during the reward period.

41. A system according to claim 34 wherein the processing portion for notifying the financial institution is further configured to notify the financial institution of the total assigned value upon expiration of the transaction period such that the interest rate is capable of being calculated according to an interest rate scheme associated with the deposit product.

42. A system according to claim 34 wherein the first computer device further comprises:
a processing portion for receiving the reward credit from the customer; and
a processing portion for adding the reward credit to an account balance corresponding to the customer such that the account balance is capable of accumulating the redemption value of the reward credit.

43. A system according to claim 34 wherein the first computer device further comprises a processing portion for presenting the reward to the customer via a display device for displaying the reward in a redemption category corresponding to a value of the reward.

44. A method for encouraging a customer to deposit monetary funds in a deposit product serviced by a financial institution, and encouraging transactions between a customer and a business entity, the method comprising:
detecting a plurality of qualified transactions between the customer and at least one business entity associated with the financial institution, each qualified transaction having an assigned value;
determining a total assigned value of the plurality of qualified transactions from the assigned values during a transaction period thereof;
notifying the financial institution of the total assigned value upon expiration of the transaction period, the financial institution being configured to apply an interest rate to the deposit product associated with the customer in response to the total assigned value received by the financial institution, the interest rate being applied to the deposit product during a reward period; and
issuing a reward credit to the customer in response to the detected at least one qualified transaction, the reward credit having a redemption value corresponding to the at least one transaction, the reward credit being redeemable in exchange for a reward corresponding to the redemption value of the reward credit, so as to encourage the customer to engage in additional transactions with the at least one business entity.

45. A method according to claim 44 wherein detecting a plurality of qualified transactions comprises identifying an association between the customer and the financial institution during each qualified transaction with the at least one business entity.

46. A method according to claim 45 wherein identifying an association further comprises at least one of:
identifying transactions between the customer and the at least one business entity during transactions conducted over a computer network system; and
identifying transactions between the customer and the at least one business entity during transactions transacted using a customer transaction device associated with the financial institution and the deposit product.

47. A method according to claim 44 wherein notifying the financial institution comprises identifying transactions between the customer and the at least one business entity by determining redemption of at least one certificate issued to the customer by the at least one business entity in response to a transaction therebetween.

48. A method according to claim 44 wherein determining a total assigned value further comprises determining a total number of transactions transacted between the customer and the at least one business entity during the transaction period such that the total number of transactions during the transaction period corresponds to the interest rate applied to the deposit product during the reward period.

49. A method according to claim 44 wherein the financial institution is further configured to provide the customer with a base interest rate associated with the deposit product upon selection thereof, the interest rate being added to the base interest rate so as to provide an increased interest rate during the reward period.

50. A method according to claim 44 further comprising:
receiving the reward credit from the customer; and
adding the reward credit to an account balance corresponding to the customer such that the account balance is capable of accumulating the redemption value of the reward credit.

51. A method according to claim 44 further comprising presenting the reward to the customer via a display device for displaying the reward in a redemption category corresponding to a value of the reward.
